(19) United States
(12) Patent Application Publication
(10) Pub. No.: US 2003/0159560 A1
(43) Pub. Date: Aug. 28, 2003

(54) Device for punching plastic materials

(76) Inventor: Georg Drescher, Westerman (DE)

Correspondence Address: BACON & THOMAS, PLLC, 625 SLATERS LANE, FOURTH FLOOR, ALEXANDRIA, VA, 22314

(21) Appl. No.: 10/275,267

(22) PCT Filed: May 14, 2001
(86) PCT No.: PCT/EP01/05467

(30) Foreign Application Priority Data
May 15, 2000 (DE) 100-23-801.7

(51) Int. Cl. B26F 1/14

(52) U.S. Cl. 83/684; 83/614

(57) ABSTRACT

The invention relates to an apparatus for punching plastics, in particular for producing plug-in punchings for smart cards, whereby the stamping punch cooperates with a die-plate and the plastic to be punched is disposed between the stamping punch and the die-plate. In order to avoid disadvantages with respect to the quality of the punched edges, the cutting edge of the stamping punch is formed according to the invention so as to have a punching angle smaller than 90°.

This invention relates to an apparatus for punching plastics according to the generic part of claim 1.

Punching apparatuses for producing plug-in punchings for smart cards have been known for some time. Known apparatuses have a stamping punch that cooperates with a support or die-plate, whereby the plastic to be punched, i.e. the smart card, is disposed between the stamping punch and the die-plate. The stamping punch is formed in known apparatuses so as to have the contour of the desired plug-in punching, a punching angle of 90° always being used to punch the plug-in free from the smart card.

Known plug-in ring punchings have the disadvantage that ink cracks occur in particular on the upper side of the punched edge. Furthermore, formation of flash is to be observed on the underside of the plug-in punched edge and chad remains on the underside. With respect to the punching apparatus, ink deposits are recognizable on the support, i.e. the die-plate, due to the high punching pressure.

International application WO-A96/31427 discloses an apparatus for cutting plastics that includes a support on which the plastic to be cut is disposed. On the side of the plastic facing away from the support a wedge-shaped cutting knife is disposed so that the plastic is cut through. The quality of the cut edges is increased by likewise using a wedge-shaped cutting knife as a support and disposing the cutting knives so that they do not touch each other during the cutting process, i.e. a narrow core remains that still connects the plug-in with the rest of the card body, the connection being such that it is easy to break the plug-in out of the card body.

This apparatus reduces the abovementioned disadvantages, but in many cases it is necessary or desirable to separate the plug-in completely from the rest of the card body over wide areas so that only a small number of bars are present that hold the plug-in detachably in the card body.

It is therefore the problem of the invention to state an apparatus for punching plug-ins that permits the plug-in to be punched free with the exception of a few bars while avoiding the disadvantages of known punching apparatuses.

This problem is solved starting out from the features of the generic part of claim 1 by the characterizing feature.

Advantageous embodiments of the invention are stated in the dependent claims.

According to the invention, it is provided that for the plug-in punchings, whereby a mini smart card in the ID-000 format is produced from a smart card in the ID-1 format, a stamping punch is used that cooperates with a support or die-plate, i.e. whereby the smart card to be punched is placed on a die-plate and a free punching in the plug-in format is produced with the stamping punch. The cutting edge of the stamping punch has a punching angle smaller than 90° according to the invention.

The inventive apparatus has the advantage that the form of the stamping punch, which now has quasi a blade at the edges, permits precise separation. This avoids ink cracks occurring on the punched edge or formation of flash on the underside of the plug-in punched edge.

According to an advantageous embodiment of the invention, the punching angle is 45°. This angle already produces a sufficiently steep blade, and the punched out material is pressed through and can be easily removed from the stamp.

According to further advantageous embodiments of the invention, it is provided that the cross section of the stamping punch is of circular or hemiellipsoidal form instead of having a fixed cutting angle of less than 90° or, according to the preceding advantageous embodiment, of 45°, i.e. being an altogether V-shaped cross section. In these embodiments, the steeper angle makes the cut edge even more precise and the punched out material is nevertheless easily removable.

According to a further advantageous embodiment of the invention, it is provided that the cut edges have a wavy form. In this way, the pressure is not built up simultaneously over the whole area when the stamping punch is pressed into the smart card material, but begins to act at the point where the wave form has its maximum and builds up slowly until the total cutting part of the stamping punch has penetrated into the material.

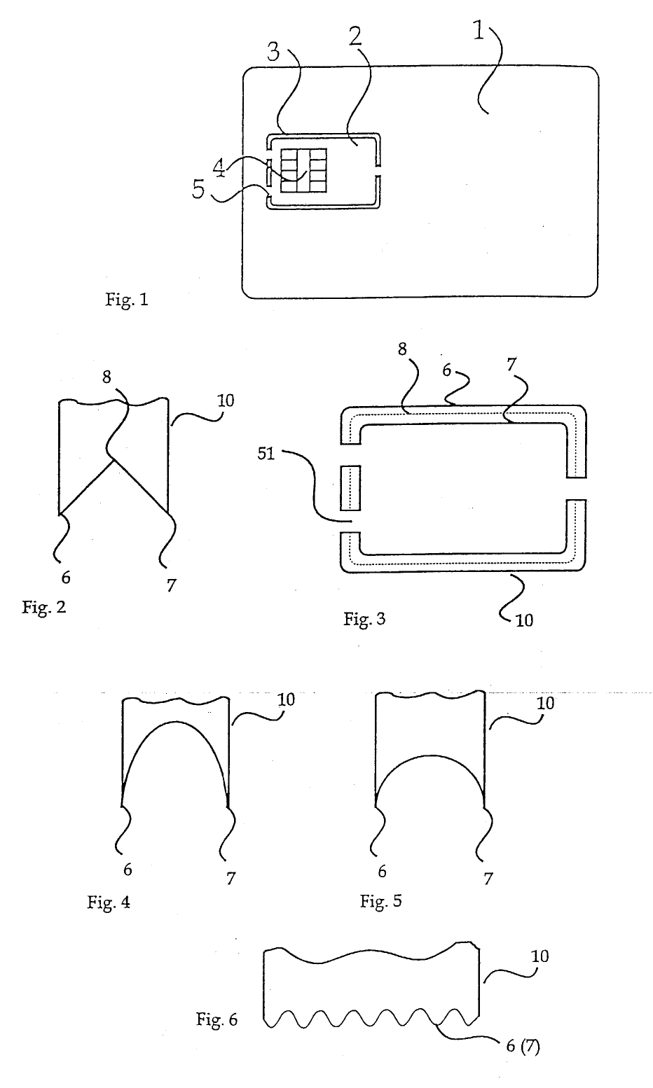

In the following the invention will be explained in more detail with reference to FIGS. 1 to 6, in which:

FIG. 1 shows a smart card with a plug-in,

FIG. 2 shows the enlarged view of a stamping punch in cross section,

FIG. 3 shows a view from below of the ring punch,

FIGS. 4 and 5 show further embodiments for the cross section of the stamping punch, and

FIG. 6 shows a side view of the stamping punch.

FIG. 1 shows smart card 1 preferably having dimensions according to the ID-1 format. Embedded therein is mini smart card 2, i.e. a plug-in in the ID-000 format. The plug-in is largely separated from the rest of the card body of smart card 1 by punchings 3. There is only a connection with the card body via bars 5. Plug-in 2 itself contains integrated circuit 4 with contact surfaces. A coil or other antenna for contactless data transfer can of course also be disposed in plug-in 2 in addition to or instead of the contact surfaces.

FIG. 2 shows a cross section of a stamping punch for producing free punch 3 of FIG. 1. In contrast to the prior art, the stamping punch according to the invention has a punching angle smaller than 90°, preferably 45°. This results in cutting points 6 and 7 that allow the edges of the punching to be free from ink cracks or formation of flash. The cross section is V-shaped with corner 8. The preferred embodiment of a 45° angle not only obtains good quality of the punched edges but also permits the punched out material to be ejected easily.

FIG. 3 shows a view from below of the ring punch. Punching points 6 and 7 are shown by continuous lines, while inner point 8 of the stamping punch is shown by dash lines. The ring punch contains interruptions 51 to obtain the bars shown in FIG. 1 connecting plug-in 2 with card body 1.

FIG. 4 shows alternative embodiments for the cross section of stamping punch 10. FIG. 4 shows a semicircular cross section in the area of the cutting edge. This cross section permits the punching angle to be made steeper at points 6 and 7, without having to accept a too tapered cross section of the recess, so that the punched out material can nevertheless be ejected easily. A steeper angle can be obtained according to FIG. 5 if a hemiellipsoidal form is chosen as the cross-sectional surface instead of the semicircular cross section.

Finally, FIG. 6 shows a side view of the punching tool wherein cutting point 7 (6) has a wavy form. This advantageously permits the punching tool to penetrate successively into the material to be cut with the use of a ring punch as stated in FIG. 3. This both makes the distribution of force more uniform and improves the cutting effect or the quality of the free punching.

In the abovementioned example, reference has been made to a plug-in punching without limiting the universality.

1. An apparatus for punching plastics, in particular for producing plug-in punchings for smart cards (1), whereby the stamping punch (10) cooperates with a die-plate or support and the plastic (1) to be punched is disposed between the stamping punch (10) and the support or die-plate, characterized in that the cutting edge of the stamping punch (10) has a punching angle smaller than 90°.

2. An apparatus according to claim 1, characterized in that the punching angle is 45° in case of a V-shaped form of the cross section of the punching tool (10).

3. An apparatus according to claim 1, characterized in that the cross section of the stamping punch is of semicircular form in the area of the cutting edge.

4. An apparatus according to claim 1, characterized in that the cross section of the stamping punch (10) has a hemiellipsoidal form in the area of the cutting edge.

5. An apparatus according to any of claims 1 to 4, characterized in that the cutting points (6, 7) of the stamping punch (10) are of wavy form.
